(19) United States
(12) Patent Application Publication
(10) Pub. No.: US 2024/0159630 A1
(43) Pub. Date: May 16, 2024

(54) METHOD FOR TISSUE PROCESSING AND TISSUE PROCESSOR

(71) Applicant: LEICA BIOSYSTEMS NUSSLOCH GMBH, Nussloch (DE)

(72) Inventors: Hermann HOPERMANN, Kastorf (DE); Hanizah AHMAD, Nussloch (DE); Hermann ULBRICH, Bad Schoenborn-Mingolsheim (DE); Hendrik THIELE, Heidelberg (DE)

(21) Appl. No.: 18/281,008

(22) PCT Filed: Mar. 10, 2022
(86) PCT No.: PCT/EP2022/056261

§ 371 Date: Sep. 8, 2023

(30) Foreign Application Priority Data
Mar. 11, 2021 (DE) 10 2021 105 932.1

(51) Int. Cl. G01N 1/30; G01N 1/31

(52) U.S. Cl. CPC G01N 1/30; G01N 1/31

(57) ABSTRACT

The invention relates to a method for tissue processing of at least one biological tissue (105), comprising processing the at least one tissue (105) using at least one fluid (110, 120, 130, 140), determining a concentration change rate in the at least one fluid (110, 120, 130, 140), and performing a measure depending on the determined concentration change rate. Further, a corresponding tissue processor (100) is proposed.

### CROSS-REFERENCE TO RELATED APPLICATIONS

The present application is a national phase entry under 35 USC § 371 of International Application PCT/EP2022/0056261 filed Mar. 10, 2022, which claims priority benefit of German Patent Application No. 10 2021 105 932.1 filed Mar. 11, 2021, the entire disclosures of which are incorporated herein by reference.

### FIELD

The present disclosure relates to a method for tissue processing of at least one biological tissue and to a tissue processor usable therefor.

### BACKGROUND OF THE DISCLOSURE

Tissue processors can be used to prepare biological tissues, on which, for example, pathological examinations are to be performed, for this examination. For example, such tissue processors are described in DE 10 2009 038 481 A1 or DE 10 2008 054 071 A1.

### SUMMARY OF THE DISCLOSURE

According to the disclosure, a method for tissue processing and a tissue processor with the features of the independent patent claims are proposed. Advantageous embodiments are the subject-matter of the dependent claims and the following description.

In detail, a method for tissue processing of at least one biological tissue according to the disclosure comprises processing the at least one tissue using at least one fluid, determining a concentration change rate in the at least one fluid, and performing a measure or action depending on the determined concentration change rate. As a result, a reasonable end of the respective processing step can be determined (as the concentration change rate decreases, the tissue chemically changes less and less) and a corresponding measure can be initiated. For example, a signal can be output as the measure to indicate the end of the processing step, or a subsequent processing step can be started automatically.

In particular, the processing can include at least partially staining of the at least one tissue. Thus, excessive staining can be avoided, which has a positive effect on the detectability of tissue features to be examined.

Alternatively or additionally, processing the at least one tissue may comprise in sequence one or more of the following steps, suitably in the order indicated: fixing the at least one tissue using at least one fixing fluid, wherein the at least one tissue is hardened, fluid exchange using a polar non-aqueous exchange solvent, wherein water is displaced from the at least one tissue and replaced by the exchange solvent, clarifying using a clarifying fluid comprising in particular a more non-polar organic solvent than the exchange solvent, wherein the exchange solvent is replaced in the at least one tissue by the clarifying fluid, and impregnating the at least one tissue using an impregnating agent, the clarifying fluid being replaced in the at least one tissue by the impregnating agent, wherein determining the concentration change rate in the fixing fluid and/or the exchange solvent and/or the clarifying fluid and/or the impregnating agent is carried out during the respective using, and at least one measure is performed in dependence on at least one of the determined concentration change rates. In this way, a consistent preparation quality can be achieved for tissue samples, regardless of their size, geometry or other properties. Excessive or insufficient infiltration of the respective fluid into the tissue is thereby reliably avoided.

In particular, the measure can comprise stopping the respective process step during which the concentration change rate was determined, and progressing to the respective following process step if the concentration change rate falls below a predeterminable threshold value. This enables extensive automation of the tissue preparation.

For example, the threshold value for the concentration change rate may be less than 20, 10, 5, or 2%/min, based on an absolute concentration of the respective species. At such small rates of change, the overall quality of tissue processing can no longer be expected to be significantly affected. Alternatively or additionally, the threshold value can be determined as a function of a size, mass or volume of the at least one tissue in order to ensure consistent processing conditions with variable sample size. It may also be advantageous to include quality requirements, such that a lower threshold value is selected for high requirements, while a higher threshold value (and associated shorter processing time) may be selected for lower quality requirements. It should be noted here that the concentration changes considered typically follow an exponential function, so that a doubling of the threshold will not typically be accompanied by a halving of the processing time.

In advantageous embodiments, the method further comprises determining at least one absolute concentration in the fluid, in particular the fixing fluid and/or the exchange solvent and/or the clarifying fluid and/or the impregnating agent, and initiating an exchange of the respective fluid when the determined absolute concentration reaches a predeterminable threshold value. In this way, a minimum quality of the fluid(s) can be ensured and the process can thus be optimized economically with regard to the utilization of the fluids without having to accept quality losses.

It should be emphasized here that each of the aforementioned processing steps can also comprise several, essentially similar individual steps. For example, the fluid exchange can be effected by several, for example 2, 3, 4, 5 or more successive baths in the respective exchange solvent. The same applies analogously to the other processing steps mentioned.

Typically, a fixing fluid contains 1 to 4% formaldehyde in aqueous solution and is stabilized with 0.5 to 2% methanol against autopolymerization. Furthermore, the fixing fluid may contain a phosphate buffer (e.g. potassium dihydrogen phosphate and/or disodium hydrogen phosphate dihydrate 1 to 12 g/1000 mL).

The exchange solvent typically contains a mixture of a simple alcohol (e.g. ethanol and/or isopropanol) and water with 10 to 99.9% alcohol content. During fluid or media exchange, lipids, in particular fats and sphingolipids (especially ceramides) and lipoproteins are typically solubilized from the tissue. Especially towards the end of a first fluid exchange step, these substances may account for a total proportion of 1 to 15% of the exchange solvent.

The clarifying fluid typically contains xylene and/or other aromatic hydrocarbons (e.g., toluene) and a simple alcohol (e.g., the alcohol(s) also contained in the exchange solvent), with the level of aromatic species in the clarifying fluid ranging from 10 to 99.9%.

The impregnating agent used is usually histological paraffin, which may contain the aromatic substances contained in the clarifying fluid, the proportion of paraffin in the impregnating agent being between 70 and 99.9%.

All concentration and proportion data refer to the volume of the mixture under consideration. Typically, concentrations of several baths of a single processing step can increase to later baths.

A tissue processor according to the disclosure comprises at least one sensor, which is arranged to determine a concentration and/or a concentration change rate in a fluid used in the tissue processor, and means which configure the tissue processor to carry out a method as described above. The tissue processor thus benefits from the explained advantages of a corresponding method mutatis mutandis and vice versa.

The sensor is preferably set up to determine the concentration and/or the concentration change rate on the basis of a sound velocity in the fluid and/or an acoustic impedance of the fluid and/or a temperature of the fluid and/or a chemical and/or an electrochemical and/or an electrical behavior of the fluid and/or optical properties of the fluid. These are particularly suitable parameters that can be used to draw precise conclusions about the concentrations of fluids or their change rates.

Further advantages and embodiments of the disclosure will be apparent from the description and the accompanying drawing.

It is understood that the above features and those to be explained below can be used not only in the combination indicated in each case, but also in other combinations or on their own, without departing from the scope of the present disclosure.

The disclosure is illustrated schematically by means of an embodiment in the drawing and is described below with reference to the drawing. Reference signs referring to a device component are also used to designate a process step carried out therein, and vice versa, in order to avoid repetition.

### BRIEF DESCRIPTION OF THE DRAWING VIEWS

FIG. 1 shows a schematic representation of an advantageous embodiment of a tissue processor according to the disclosure.

FIG. 2 shows typical concentration curves that can occur in fluids within the scope of the present disclosure.

### DETAILED DESCRIPTION

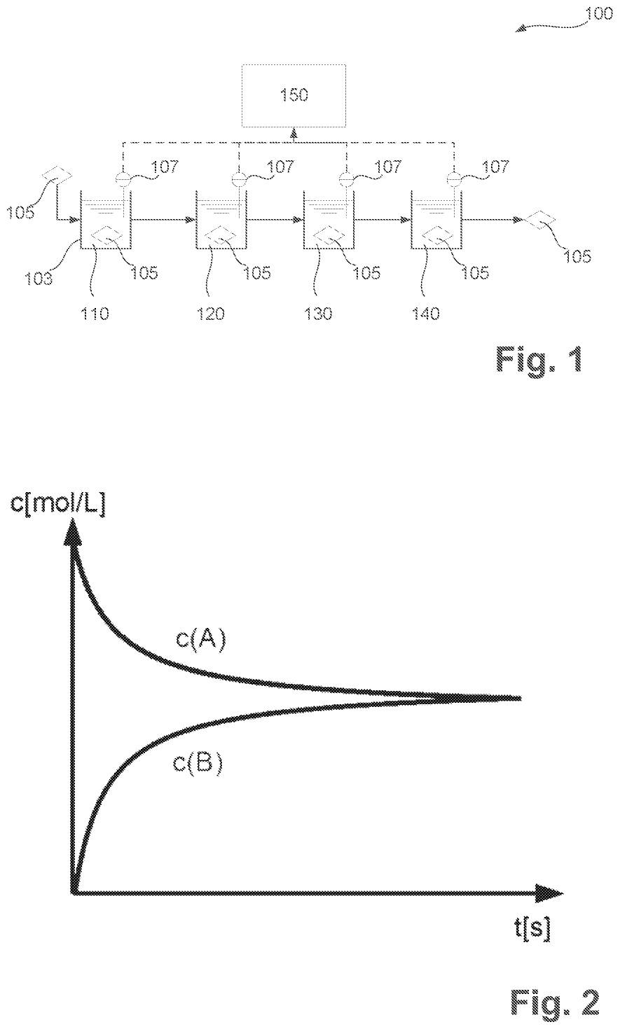

In FIG. 1, an advantageous embodiment of a tissue processor according to the disclosure is shown schematically and designated 100 overall.

The tissue processor 100 includes at least one retort 103 suitable and configured for receiving one or more biological tissues or samples 105 and for filling with at least one organic fluid. In particular, the retort may comprise one or more materials selected from the group consisting of stainless steel, aluminum and other metals, polyethyl ether ketone (PEEK), polytetrafluoroethylene (PTFE), polyethylene (PE), polypropylene (PP), polycarbonate (PC) and other suitable plastics, and glass.

Further, the tissue processor 100 comprises a sensor 107 arranged to detect a concentration and/or a concentration change rate and/or other parameters that can be used to determine a concentration or concentration change rate. To this end, the sensor 107 is arranged to detect the respective parameter(s) with reference to a content of the retort 103. For example, the sensor 107 may be disposed in a wall of the retort 103 or may extend into an interior volume of the retort 103.

For example, the sensor may be a device that detects a sonic velocity and/or an impedance of the fluid under test. These parameters change with the concentration of various chemical species in a matrix fluid and can be measured very precisely. However, other types of sensors can be used as the sensor 107, especially those that allow concentration measurement (e.g., pH electrodes, spectrometers, or the like)

From such measured parameters, a computing unit 150 of the tissue processor can determine the concentration or concentration change rate in the retort. In some embodiments, the determination of the concentration or concentration change rate may also be performed integrally within the sensor 107, for example, using a dedicated computing unit of the sensor, which may be provided, for example, in the form of an integrated circuit, microprocessor, or other suitable device for data processing.

A concentration change rate can also be determined by determining an absolute concentration in conjunction with an evaluation of its temporal course. For this purpose, for example, a derivative of a suitably filtered and/or smoothed temporal concentration course can be formed. It may also be possible to evaluate a concentration change rate without determining an actual concentration, since in principle the raw data course of a sensor signal generated by the sensor 107 can also be used for this purpose. If the sensor signal is constant, the underlying concentration is also constant and thus its change rate is zero. If the sensor signal change rate is high, on the other hand, a high concentration change rate can also be assumed.

Local differences in concentration within the retort 103 can be reduced by suitable mixing, for example by means of an agitator (not shown in the figure), to avoid variations in the measurements of the sensor 107.

In order to accelerate the (passive) reagent exchange at the interface of the tissue, the retort 103 and thus the fluids used can be heated. This enhances Brownian molecular motion and thus increases the corresponding diffusion rates, which are ultimately responsible for the infiltration of the tissue 105.

In FIG. 2, typical concentration curves that can occur in fluids in the context of the present disclosure are shown in simplified form as a concentration-time diagram and labeled c(A) and c(B). The abscissa forms the time axis, while the ordinate indicates the respective concentration. It should be explicitly noted that the positioning and scaling of the two concentration curves c(A) and c(B) relative to each other has a purely illustrative purpose and does not allow any conclusions to be drawn about respective absolute concentrations or relative concentrations of the species concerned. In particular, it should be noted that the axis intercept need not coincide with a zero value on the respective axis. Correctly shown, however, is the internal relative course of both concentration courses c(A) and c(B): In the case of species A, this is a component which is contained in the fluid in question and is introduced into the processed tissue 105, as a result of which the concentration within the fluid decreases in the course of the respective process step until equilibrium has been reached. Species B, on the other hand, is a compound that is present or formed within the tissue 105 and passes from the tissue into the fluid during the respective process step, so that its concentration in the fluid increases during the process step until the concentrations in the tissue 105 and fluid have equalized or equilibrium has been reached. In both concentration courses c(A) and c(B), an asymptotic course results, since the driving force of the change in concentration, namely the difference in concentration between tissue 105 and surrounding fluid, decreases as time progresses. The lower the concentration difference in question, the lower the corresponding net diffusion rate, which reduces the concentration difference, resulting in a decreasing slope of the respective concentration curve c(A), c(B).

In the operation of the tissue processor or an advantageous embodiment of a process according to the disclosure, which may be implemented in the tissue processor 100, the tissue sample 105 is successively exposed to several different process media 110, 120, 130, 140 in the form of fluids, wherein in the example shown here, a fixing fluid 110 is first applied, which serves to harden the tissue. For example, formaldehyde, paraformaldehyde, glutaraldehyde, other aldehydes, acetone or alcoholic fixatives and solutions and/or mixtures thereof may be used for this purpose. Usually, a 3.7% formalin solution (3.7% formaldehyde solution in water buffered with phosphate salts to a neutral pH) is used for this purpose. It may be envisaged that the fixing fluid 110 is applied once or more times to the same sample 105. When tissue is introduced into this fixing fluid, for example the aforementioned formalin solution, the formaldehyde concentration of the solution initially decreases over time because the tissue absorbs and consumes it (cross-linking of proteins). Such a decrease in concentration c(A) is schematically shown in FIG. 2, as described above.

Fixation 110 is followed by one or more steps of fluid exchange with an exchange solvent 120. This is done by immersing the tissue sample 105 in the exchange solvent (or removing the fixation fluid from the retort and introducing exchange solvent into the retort) so that the exchange solvent 120 completely covers the sample 105. This displaces any remaining water from the sample 105, dissolves fats, and washes out residues of the fixing fluid 110. Therefore, the concentration of the main component of the exchange solvent 120 decreases analogously to the concentration curve c(A) described above, while the concentration of species (fats, water, fixing fluid 110) dissolved or displaced from the tissue 105 increases in the exchange solvent 120 according to the concentration curve c(B) shown in FIG. 2. In particular, ethanol, methanol, isopropanol and other aliphatic as well as non-aliphatic alcohols as well as mixtures thereof can be considered as the exchange solvent, e.g. 70% ethanol. Crucially, the exchange solvent 120 used may be miscible with water, or water may have as a relatively high solubility in the exchange solvent 120 used. Fluid exchange may also be carried out in a plurality of steps, for example 2, 3, 4, 5 or up to 10 or 20, preferably using an exchange solvent 120 of higher purity in later steps than in earlier steps to reduce costs and still achieve high quality processing. In particular, the exchange solvent 120 of the final fluid exchange step may be anhydrous.

Practical example: Tissue 105, which was previously infiltrated in formalin solution 110 (96.3 vol % water), is introduced into e.g. 70% ethanol 120 in the second step. Here, the water of tissue 105 is exchanged for the surrounding ethanol 120. This decreases the ethanol concentration (c(A)) in the exchange solvent 120 around the tissue 105. This does not decrease further after some time t[s]. The tissue 105 then has a substantially identical ethanol concentration to the exchange solvent 120. The sensor 107 senses this substantially asymptotic decrease in concentration c(A), as explained above. When the concentration of the exchange solvent 120 has stabilized, it is pumped or replaced from the retort 103, for example.

Conversely, the tissue 105 introduced into ethanol 120, for example, also releases substances into the reagent over time, e.g. fat and certain proteins. If the amount of substances (concentration curve c(B) in FIG. 2) of these released components does not increase further, complete tissue infiltration can be assumed after a time t[s]. The sensor system monitors this increase in quantity and the system can then start the next process step. This can be sensed particularly well in the first steps of the fluid exchange, since these substances are then quantitatively dissolved out and accordingly no further change in concentration of these substances is to be expected.

In the illustrated example, fluid exchange with 120 is followed by clarification of the tissue 105 using a clarifying fluid 130 that replaces the exchange solvent 120 within the tissue 105. In particular, isopropanol, chloroform, xylene, toluene and other aromatic hydrocarbon compounds, as well as mixtures and non-aqueous solutions thereof, may be used as the clarifying fluid 130. Here, again, a miscibility or solubility of the exchange solvent 120 used in the clarifying fluid 130 is critical. Multiple steps, for example 2, 3, 4 or even more steps, are also possible in the clarifying process, whereby different steps of the clarifying process can be carried out with different clarifying fluids 130 in each case (in terms of identity, purity and/or mixing ratio). In particular, a clarifying fluid 130 with relatively high polarity can be used in early steps of clarification, and a clarifying fluid with lower polarity can be used in later clarification steps. This results in better miscibility in each case with fluid used previously or subsequently.

Subsequently, the tissue 105 is impregnated with an impregnating agent 140. In particular, mixtures of various branched and/or unbranched alkanes with suitable additives can be used as the impregnating agent. Particularly preferred impregnating agents are those which form solids with sufficient strength at temperatures below 20° C. and above −70° C., and in particular also at temperatures above −20° C., to permit thin sections of a composite of tissue 105 and cooled impregnating agent 140.

In one embodiment of such a method according to the disclosure, a concentration change rate in the corresponding fluid 110, 120, 130, 140 is determined in at least one of the steps described. The sensor 107 is used for this purpose. For example, during fluid exchange, a concentration change rate of water in the respective exchange solvent 120 can be determined. This concentration change rate, as already explained with reference to FIG. 2, naturally decreases during the course of each step until an equilibrium concentration is established. Once the equilibrium concentration has been established, no further concentration change is to be expected, and the concentration change rate (slope of the respective concentration curves c(A), c(B) in FIG. 2) thus drops to zero. Therefore, the concentration change rate can be used to detect the de facto end of a process step. If the rate drops below a predetermined threshold value, which can be especially close to zero, the respective step can be considered as finished. Preferably, a signal is then output to prompt a user of the tissue processor to initiate the respective next step, or the next step is initiated automatically, for example by replacing the fluid currently in the retort 103 with another fluid used for the subsequent step.

In practice, the concentration change rate can also be determined by comparing a currently determined measured value with the measured value determined directly before it (e.g. by means of a quotient or a difference). Depending on the result of the comparison, the threshold value for the concentration change rate can be considered to have been reached. For example, such a quotient, which has a small distance of 1, or a corresponding difference, which has a small distance of 0, can be used as a corresponding indication.

It should be noted in this regard that all steps may be performed in the same retort 103, such that, for example, an outlet port and an inlet port may be provided in the retort for removal of the earlier fluid and introduction of the later fluid. In such embodiments, no manipulation of the processed tissue 105 is required, thereby minimizing the risk of damage to the tissue 105. In alternative embodiments, each of the steps may be performed in a separate retort 103, and in such embodiments, for example, a basket may be used to hold the tissue 105, such that in each case the basket may be inserted into the respective retort 103 to provide contact of the tissue 105 with the respective fluid.

Monitoring of concentration or concentration change rate may generally involve all compounds present in the particular fluid, for example, gases dissolved or suspended in a fluid, a major component of the particular fluid, and/or substances passing from tissue 105 into the fluid.

In any case, an end of the respective process step is to be assumed when the concentration change rate tends towards zero, so that a determination of an absolute concentration is not necessary. As already explained, this has the advantage of considerably simpler data processing, since, if necessary, a calibration of the sensor 107 to the respective fluid and the compound to be analyzed can be omitted and a conversion of the sensor signals into the respective concentrations is not necessary. An observation of the raw signal is sufficient in each case for assessing the concentration change rate. At most, different threshold values for different process steps are required to take into account the absolute concentration changes to be expected in each case. For example, significantly higher rates of concentration change can be expected in a first step of the fluid exchange process than in its last step, since nearly pure exchange solvent 120 is already present within the sample towards the end of the fluid exchange process and the difference in concentration between tissue 105 and exchange solvent 120 is therefore comparatively small.

This monitoring of the concentration change rates can be applied to each of the previously explained process steps, so that overall an extensive automation of the tissue processing is made possible. Conventionally, the problem arises that different sample sizes require very different processing times and these must be determined empirically. In the context of the disclosure, the optimal processing time in each case is automatically determined by monitoring the concentration change rates, thus ensuring consistent processing quality.

Typically, a ratio of a volume of the tissue to a volume of the fluid used should not leave a range of 1:1 to 1:50 in order to be able to derive reliable statements regarding the process progress from the concentration change rate. If the tissue volume is too small compared to the fluid volume, the concentration change rate may not be recorded with sufficient accuracy.

As mentioned above, such monitoring of concentration change rates can also be used to control other processing of biological tissue 105. For example, staining of certain tissue parts can be monitored and controlled by monitoring a dye concentration in a staining solution, as the concentration change rate is also steadily decreasing in this case.

Furthermore, regardless of the specific design of the respective process step, a depletion of solutions or fluids of substances consumed in a process step can be determined by the rate of change at the beginning of the respective process step being lower than a predeterminable threshold value. In particular, such a threshold value describing a too low concentration of a fluid may be dependent on a sample size of the processed tissue 105, since a low concentration change rate is to be expected for a small sample size. The same may apply analogously to the threshold value used to determine an end of a process step. Therefore, if the concentration change rate falls below a predeterminable threshold value at the beginning of a process step, for example, a replacement of the fluid in question may be triggered or stimulated.

It should be emphasized here that the features and their respective advantages can be realized not only in the indicated combination but also in other combinations and, if necessary, in a stand-alone position without leaving the scope of the present disclosure.

What is claimed is:

1. A method for tissue processing of at least one biological tissue (105), comprising
processing the at least one tissue using at least one fluid (110, 120, 130, 140),
determining a concentration change rate in the at least one fluid (110, 120, 130, 140), and
performing a measure depending on the determined concentration change rate.

2. The method of claim 1, wherein the processing comprises at least partially staining the at least one tissue (105).

3. The method for tissue processing of at least one biological tissue according to claim 1, wherein the processing of the at least one tissue (105) comprises sequentially one or more of the following steps, in the order indicated:
fixing of the at least one tissue (105) using at least one fixing fluid (110), wherein the at least one tissue (105) is hardened,
fluid exchange using a polar non-aqueous exchange solvent (120), wherein water is displaced from the at least one tissue (105) and replaced by the exchange solvent (120),
clarifying using a clarifying fluid (130) comprising in particular a less polar organic solvent than the exchange solvent (120), wherein the exchange solvent (120) is replaced by the clarifying fluid (130) in the at least one tissue (105), and
impregnating the at least one tissue (105) using an impregnating agent (140), wherein the clarifying fluid (130) in the at least one tissue (105) is replaced by the impregnating agent (140),
wherein said determining of the concentration change rate in said fixing fluid (110) and/or said exchange solvent (120) and/or said clarifying fluid (130) and/or said impregnating agent (140) is performed during the respective using, and
at least one measure is performed depending on at least one of the determined concentration change rates.

4. The method according to claim 1, wherein the measure comprises an ending of a respective method step during which the concentration change rate was determined and a progressing to a respective following method step if the concentration change rate falls below a predeterminable threshold value.

5. The method according to claim 1, further comprising:
determining at least one absolute concentration in the at least one fluid (110, 120, 130, 140), and
initiating a replacement of the respective at least one fluid (110, 120, 130, 140) when the determined absolute concentration reaches a predeterminable threshold value.

6. A tissue processor (100) comprising at least one sensor (107) arranged to detect a concentration and/or a concentration change rate in a fluid (110, 120, 130, 140) used in the tissue processor (100), and means configuring the tissue processor (100) to perform a method according to claim 1.

7. The tissue processor (100) according to claim 6, wherein the sensor (107) is adapted to determine the concentration and/or concentration change rate based on a speed of sound in the fluid (110, 120, 130, 140) and/or an acoustic impedance of the fluid (110, 120, 130, 140) and/or a temperature of the fluid (110, 120, 130, 140) and/or a chemical and/or an electrochemical and/or an electrical behavior of the fluid (110, 120, 130, 140) and/or optical properties of the fluid (110, 120, 130, 140).

8. The method according to claim 3, wherein performing the measure comprises ending a respective processing step of the method during which the concentration change rate was determined and progressing to a respective following processing step of the method if the concentration change rate falls below a predeterminable threshold value.

9. The method according to claim 3, further comprising:
determining at least one absolute concentration in the fixing fluid (110) and/or the exchange solvent (120) and/or the clarifying fluid (130) and/or the impregnating agent (140), and
initiating a replacement of the fixing fluid (110) and/or the exchange solvent (120) and/or the clarifying fluid (130) and/or the impregnating agent (140) when the respective determined absolute concentration thereof reaches a predeterminable threshold value.
